(19) United States
(12) Patent Application Publication
(10) Pub. No.: US 2026/0118240 A1
(43) Pub. Date: Apr. 30, 2026

(54) METHOD FOR PREDICTING OCCURRENCE OF ELECTRODE CRACK AND DELAMINATION

(71) Applicant: LG ENERGY SOLUTION, LTD., Seoul (KR)

(72) Inventors: Ji Hwan KIM, Daejeon (KR); Oh Cheol KWON, Daejeon (KR); Soon Sik CHOI, Daejeon (KR); Youngkuk KO, Daejeon (KR); Jeongwon LEE, Daejeon (KR)

(21) Appl. No.: 18/687,777

(22) PCT Filed: Mar. 7, 2023
(86) PCT No.: PCT/KR2023/003059

§ 371 Date: Jun. 12, 2025

(30) Foreign Application Priority Data
Apr. 19, 2022 (KR) 10-2022-0047900
Feb. 9, 2023 (KR) 10-2023-0017429

(51) Int. Cl. G01N 3/42

(52) U.S. Cl. CPC G01N 3/42; G01N 2203/0064; G01N 2203/0298

(57) ABSTRACT

The present disclosure relates to a method for predicting the occurrence of electrode crack and delamination, and the objective of the present disclosure is to provide a method for predicting the occurrence of electrode crack and delamination, the method comprising: measuring crack force for a dried electrode; and predicting the occurrence of crack and delamination of the electrode on the basis of the measured crack force.

### CROSS-REFERENCE TO RELATED APPLICATIONS

The present application is a National Phase entry pursuant to 35 U.S.C. § 371 of International Application No. PCT/KR2023/003059, filed on Mar. 7, 2023, and claims the benefit of and the priority to Korean Patent Application No. 10-2022-0047900, filed on Apr. 19, 2022, and Korean Patent Application No. 10-2023-0017429, filed on Feb. 9, 2023, the entire contents of which are hereby incorporated by reference in their entirety.

### TECHNICAL FIELD

The present disclosure relates to a method for predicting occurrence of cracks and delamination of an electrode, in particular a method for predicting occurrence of cracks and delamination of an electrode comprising measuring a crack force of the dried electrode and predicting occurrence of cracks and delamination of the electrode based on the measured crack force.

### BACKGROUND

The manufacturing method of electrode for a secondary battery may comprise a mixing process of mixing an active material with a conductive material, a binder, and a solvent to form an electrode slurry, a coating process of applying the electrode slurry to a current collector, a drying process of drying the applied electrode slurry, and a slitting process for cutting the battery to meet the designed battery specifications.

Here, defects such as cracks and delamination may occur due to stress from drying and in the process of slitting the electrode in the manufacturing method of the electrode.

Cracks can occur due to stress from drying. When drying the electrode, there is a difference in the behavior of the thermal contraction or expansion between the foil and the slurry. Therefore, excessive heat is applied to the dried electrode by evaporation of the internal solvent, the electrode may have wrinkles and cracks like cracks on dry land.

Delamination is intended to mean that the electrode at the punched portion in the process of directly punching an electrode through a knife falls like crumbs from the foil.

To prevent the above phenomena, the adhesive force of the electrode slurry is generally measured, but it is difficult to predict 100% of the above defect phenomena using adhesive force. In particular, the adhesive force can be used as an index expressing the attractive force between the foil and the electrode. However, there is a limit to account for the cohesive force (coating cohesive force) between particles in the electrode using the adhesive force, and thus a new index is needed.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

### Technical Problem

The present disclosure relates to a method for predicting occurrence of cracks and delamination of an electrode and provides a method for predicting occurrence of cracks and delamination of an electrode comprising measuring a crack force of the dried electrode and predicting occurrence of cracks and delamination of the electrode based on the measured crack force.

The technical problems to be achieved by the present disclosure are not limited to the above-mentioned technical problems, and other technical problems not mentioned will be clearly understood by those skilled in the art from the description below.

### Solution to Problem

The method for predicting occurrence of cracks and delamination of the electrode of the present disclosure may comprise:
a step of preparing an electrode to be analyzed by applying an electrode slurry on one surface of an electrode current collector and then drying it;
a step of press-fitting a measuring point into a surface of the electrode to be analyzed;
a step of collecting data by collecting indentation load values applied to the measuring point for each indentation depth value of the measuring point for the electrode to be analyzed;
a step of extracting a crack force by extracting an indentation load value at the time that the electrode to be analyzed is broken as a crack force value; and
a prediction step of predicting occurrence of cracks and delamination of the electrode to be analyzed using the crack force value.

### Effect of the Invention

The method for predicting occurrence of cracks and delamination of the electrode according to the present disclosure can provide data for reducing defects in an electrode manufacturing process by predicting the possibility of occurrence of cracks and delamination of the electrode.

The method for predicting occurrence of cracks and delamination of the electrode according to the present disclosure can accurately express the characteristics of cohesive force between particles in the electrode.

### BRIEF DESCRIPTION OF DRAWINGS

FIG. 1 is a block diagram showing a method for predicting occurrence of cracks and delamination of an electrode of the present disclosure.

FIG. 2 is a cross-sectional view showing a cross-section of an electrode to be analyzed prepared in a step of preparing an electrode to be analyzed.

FIG. 3A is a front view showing a measuring point.

FIG. 3B is a side view showing a measuring point.

FIG. 4 is a cross-sectional view showing that a measuring point is press-fitted into the electrode to be analyzed.

FIG. 5 is a graph showing an indentation load as a function of an indentation depth.

### DETAILED DESCRIPTION

The method for predicting occurrence of cracks and delamination of the electrode of the present disclosure may comprise:
a step of preparing an electrode to be analyzed by applying an electrode slurry to one surface of an electrode current collector and then drying it;
a step of press-fitting a measuring point into a surface of the electrode to be analyzed;
a step of collecting data by collecting indentation load values applied to the measuring point for each indentation depth value of the measuring point for the electrode to be analyzed;
a step of extracting a crack force by extracting an indentation load value at the time that the electrode to be analyzed is broken as a crack force value; and
a prediction step of predicting occurrence of cracks and delamination of the electrode to be analyzed using the crack force value.

In the step of preparing the electrode to be analyzed of the method for predicting occurrence of cracks and delamination of the electrode of the present disclosure, the electrode current collector may be made of a metal foil, and the electrode slurry may be prepared by mixing an active material, a conductive agent, a binder, and a solvent.

In the step of press-fitting of the method for predicting occurrence of cracks and delamination of the electrode of the present disclosure, one end of the measuring point may be an edge formed by an intersection of a first plane and a second plane at an acute angle with each other, and the measuring point may be press-fitted into the electrode to be analyzed while contacting the edge of the measuring point with the surface of the electrode to be analyzed.

In the method for predicting occurrence of cracks and delamination of the electrode of the present disclosure, a length of the edge formed by the first plane and the second plane may be 2 mm to 10 mm, and the acute angle formed by the first plane and the second plane may be 15 degrees to 45 degrees.

In the method for predicting occurrence of cracks and delamination of the electrode of the present disclosure, the measuring point may move in a direction perpendicular to the surface of the electrode to be analyzed and be press-fitted into the surface of the electrode to be analyzed, and the measuring point may move at a speed of 50 μm/s or less.

In the step of extracting a crack force of the method for predicting occurrence of cracks and delamination of the electrode of the present disclosure, the crack force value may be the indentation load value when the indentation load value has a maximum value with respect to the indentation depth value.

In the prediction step of the method for predicting occurrence of cracks and delamination of the electrode of the present disclosure, it may be predicted that the smaller the crack force value, the greater the probability of occurrence of cracks or delamination in the electrode to be analyzed.

In the prediction step of the method for predicting occurrence of cracks and delamination of the electrode of the present disclosure, the indentation depth value when the indentation load value is the crack force value may be considered together with the crack force value in predicting occurrence of cracks or delamination of the electrode to be analyzed.

In the prediction step of the method for predicting occurrence of cracks and delamination of the electrode of the present disclosure, it may be predicted that the smaller the indentation depth value when the indentation load value is the crack force value, the greater the probability of occurrence of cracks or delamination in the electrode to be analyzed.

In the prediction step of the method for predicting occurrence of cracks and delamination of the electrode of the present disclosure, a strain energy value may be calculated by integrating the indentation load values up to the indentation depth value when the indentation load value is the crack force value, and the occurrence of cracks and delamination of the electrode to be analyzed may be predicted based on the strain energy value.

In the prediction step of the method for predicting occurrence of cracks and delamination of the electrode of the present disclosure, it may be predicted that the smaller the strain energy value, the greater the probability of occurrence of cracks or delamination in the electrode to be analyzed.

The method for predicting occurrence of cracks and delamination of the electrode of the present disclosure may further comprise, prior to the step of preparing the electrode to be analyzed,
a step of preparing a standard electrode by applying a standard electrode slurry to one surface of an electrode current collector and then drying it;
a step of press-fitting the measuring point into the surface of the standard electrode;
a step of collecting reference data by collecting indentation load values applied to the measuring point for each indentation depth value of the measuring point for the standard electrode; and
a step of extracting a reference force by extracting an indentation load value at the time that the standard electrode is broken as a reference force value;
wherein in the prediction step, the occurrence of cracks and delamination of the electrode to be analyzed may be predicted using the crack force value and the reference force value.

In the prediction step of the method for predicting occurrence of cracks and delamination of the electrode of the present disclosure, when the crack force value is 70% or less of the reference force value, the electrode to be analyzed may be predicted as an electrode in which cracks and delamination are to occur.

### MODE FOR CARRYING OUT THE INVENTION

Hereinafter, embodiments according to the present disclosure will be described in detail with reference to the accompanying drawings. In this process, the size or shape of the components illustrated in the drawings may be exaggerated for clarity and convenience of description. In addition, terms specifically defined in consideration of the configuration and operation of the present disclosure may vary according to the intention or custom of users or operators. Definitions of these terms should be made based on the contents throughout this specification.

In the description of the present disclosure, it should be noted that the terms “center”, “top”, “bottom”, “left”, “right”, “vertical”, “horizontal”, “inside”, “outside”, “one surface”, “other surface”, etc. are based on the orientation or positional relationship shown in the drawings or the orientation or positional relationship normally arranged when using the product of the present disclosure. It is only for explanation and brief description of the present disclosure and is not to be construed as limiting the present disclosure as it does not suggest or imply that the devices or elements indicated must necessarily be configured or operated in a specified orientation.

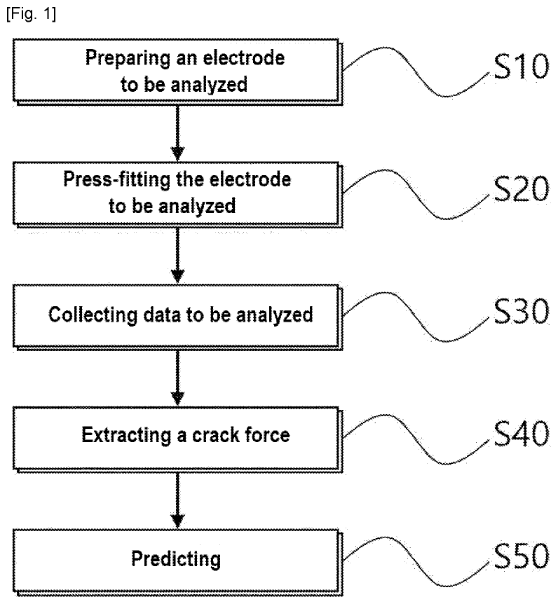

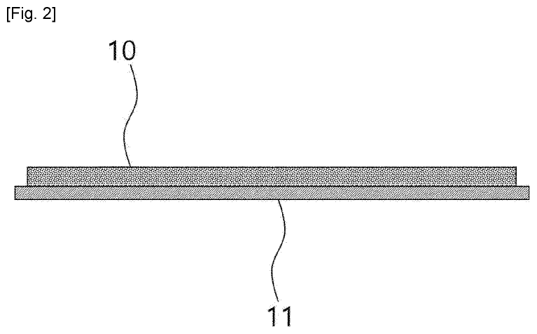

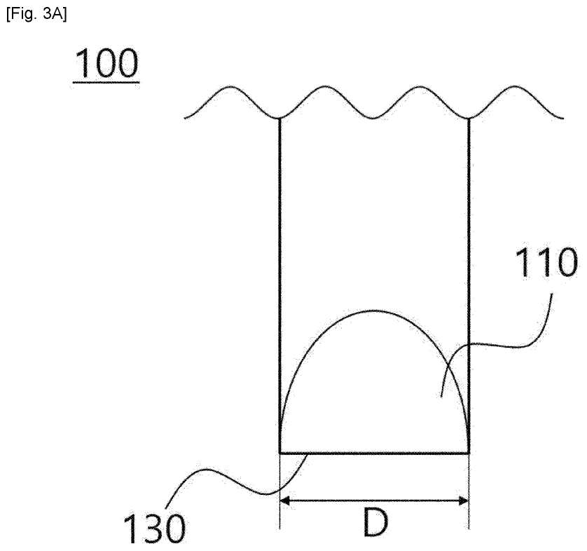

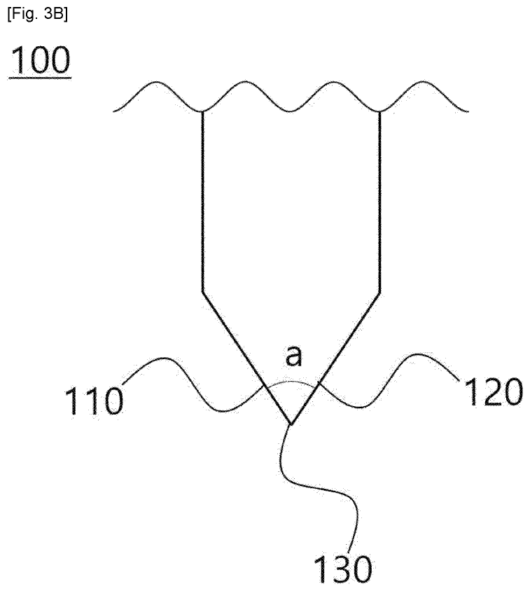

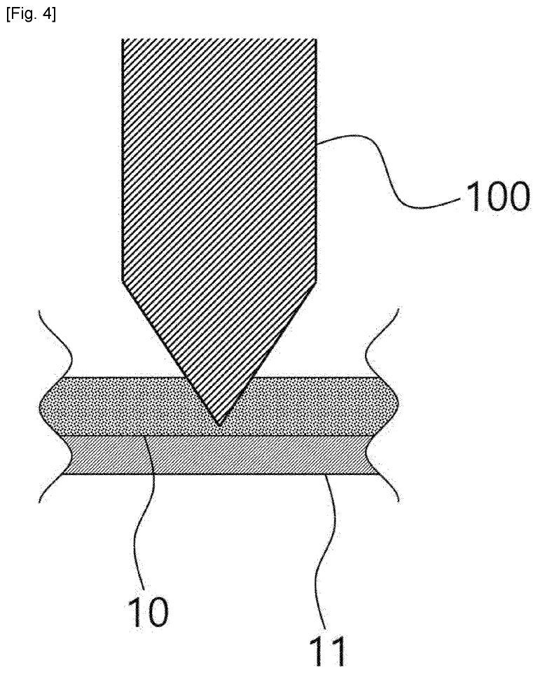

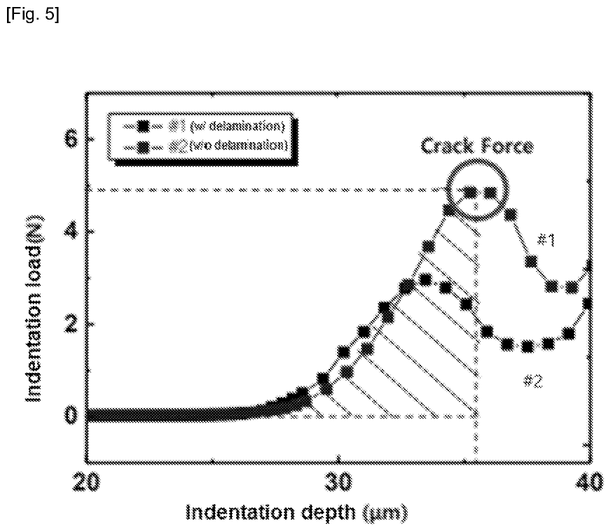

FIG. 1 is a block diagram showing a method for predicting occurrence of cracks and delamination of an electrode of the present disclosure. FIG. 2 is a cross-sectional view showing a cross-section of an electrode to be analyzed prepared in a step of preparing an electrode to be analyzed. FIG. 3a is a front view showing a measuring point. FIG. 3b is a side view showing a measuring point. FIG. 4 is a cross-sectional view showing that a measuring point is press-fitted into the electrode to be analyzed. FIG. 5 is a graph plotting an indentation load as a function of an indentation depth.

Hereinafter, with reference to FIGS. 1 to 5, the method for predicting occurrence of cracks and delamination of the electrode according to the present disclosure will be described in detail.

The method for predicting occurrence of cracks and delamination of the electrode of the present disclosure is for predicting the probability of occurrence of cracks or delamination in the electrode in the manufacturing process of the electrode wherein the crack force described later may be used as an index.

As shown in FIG. 1, the method for predicting occurrence of cracks and delamination of the electrode may comprise:
a step of preparing an electrode to be analyzed (S10) of preparing an electrode 10 to be analyzed by applying an electrode slurry to one surface of an electrode current collector 11 and then drying it;
a step of press-fitting the electrode to be analyzed (S20) of press-fitting a measuring point 100 into the surface of the electrode 10 to be analyzed;
a step of collecting data to be analyzed (S30) of collecting indentation load values applied to the measuring point 100 for each indentation depth value of the measuring point 100 for the electrode 10 to be analyzed;
a step of extracting a crack force (S40) of extracting an indentation load value at the time that the electrode 10 to be analyzed is broken as a crack force value; and
a prediction step (S50) of predicting occurrence of cracks and delamination of the electrode 10 to be analyzed using the crack force value.

In the step of preparing the electrode to be analyzed (S10), the electrode current collector 11 may be made of a metal foil, and the electrode current collector 11 may be prepared by mixing an active material, a conductive agent, a binder, and a solvent.

Specifically, in the step of preparing an electrode to be analyzed (S10), the electrode 10 to be analyzed may be prepared by performing steps prior to a slitting process in a general electrode manufacturing process. For example, a mixing process, a coating process of applying the electrode slurry to the current collector, a pressing process of pressing the electrode, and a drying process of drying the applied electrode slurry may be performed to prepare an electrode 10 to be analyzed. The electrode 10 to be analyzed may include, without limitation, a positive electrode and a negative electrode. However, since the positive electrode and the negative electrode have different physical properties from each other, the measurement may be performed under different conditions in the subsequent step of press-fitting the electrode to be analyzed (S20), etc.

As shown in FIG. 2, the electrode 10 to be analyzed may be formed by drying the electrode slurry applied to one surface of the electrode current collector 11.

In the step of press-fitting the electrode to be analyzed (S20), one end of the measuring point 100 is formed as a cusp, and one end of the measuring point 100 formed as the cusp may be inserted into the surface of the electrode by force.

Specifically, as shown in FIGS. 3a and 3b, one end of the measuring point 100 may be an edge 130 formed by the intersection of a first plane 110 and a second plane 120 at an acute angle with each other. That is, the cusp of the measuring point 100 may be provided as an edge 130 formed by the intersection of two planes.

The measuring point 100 may be press-fitted into the electrode 10 to be analyzed while contacting the edge 130 of the measuring point 100 with the one surface of the electrode 10 to be analyzed. More specifically, the measuring point 100 and the electrode 10 to be analyzed are aligned so that the direction of the edge 130 of the measuring point 100 is parallel to the one surface of the electrode 10 to be analyzed, the measuring point 100 may move to approach the electrode 10 to be analyzed, and the measuring point 100 may be press-fitted into the electrode 10 to be analyzed.

As shown in FIG. 3a, the length D of the edge 130 formed by the first plane 110 and the second plane 120 may be 2 mm to 10 mm, and as shown in FIG. 3b, an angle a formed by the first plane 110 and the second may be 15 degrees to 45 degrees. The length of the edge 130 and the angle between the two planes are determined in consideration of the material or state of the electrode 10 to be analyzed as sensitivity for detecting the crack force as described below, while inserting the measuring point 100. For example, when the electrode 10 to be analyzed is formed as a negative electrode, the length D of the edge 130 may be 6 mm, and when the electrode 10 to be analyzed is formed as a positive electrode, it may be 3 mm. For example, the angle a formed by the first plane 110 and the second plane 120 may be 32 degrees.

As shown in FIG. 4, the measuring point 100 may move in a direction perpendicular to the one surface of the electrode 10 to be analyzed and be press-fitted into the one surface of the electrode 10 to be analyzed. Specifically, the measuring point 100 may move in a direction perpendicular to the edge 130 of the measuring point 100 and one surface of the electrode 10 to be analyzed and be press-fitted into the electrode 10 to be analyzed. That is, in FIG. 4, the measuring point 100 may move in a vertical direction.

The measuring point 100 may move at a speed of 50 μm/s or less. The measuring point 100 may be press-fitted into one surface of the electrode 10 to be analyzed while moving at a constant speed. Thus, because of the constant speed, the indentation load depends on the state (normal state, rupture state, etc.) of the electrode 10 to be analyzed while press-fitting, and therefore it can be collected and used as analysis data. The speed of the measuring point 100 may be selected within a range where the indentation load is maintained at 20 gf or less for the negative electrode and it may be selected within the range where the indentation load is maintained at 40 gf or less for the positive electrode. For example, the measuring point 100 may move at a speed of 10 μm/s.

In the step of collecting data to be analyzed (S30), a distance the measuring point 100 moves in a direction perpendicular to the one surface of the electrode 10 to be analyzed is defined as an indentation depth. Indentation load values may be collected for the indentation depth that varies while the measuring point 100 moves. The indentation load value may be a load value applied to the measuring point 100 in a direction perpendicular to the one surface of the electrode 10 to be analyzed when the measuring point 100 moves.

As shown in FIG. 5, in the step of extracting a crack force (S40), the crack force value may be an indentation load value when the indentation load value has a maximum value with respect to an indentation depth value. As the measuring point 100 is press-fitted into the electrode, an increasingly larger indentation load is applied to the measuring point 100. At the time that the electrode 10 to be analyzed is completely broken, the indentation load applied to the measuring point 100 is partially released. As shown in FIG. 5, there is a maximum value, which can be determined as a crack force value.

In the prediction step (S50), it may be predicted that the smaller the strain energy value, the greater the probability of occurrence of cracks or delamination in the electrode to be analyzed. In the method for predicting occurrence of cracks and delamination of the electrode of the present disclosure, the crack force is a value related to the interparticle attraction within the electrode, and the stronger the interparticle attraction, the longer the electrode can withstand the insertion of the measuring point 100, and an electrode having stronger interparticle attraction may have a larger crack force value. Therefore, since cracks or delamination do not easily occur in electrodes having strong interparticle attraction, it may be predicted that the smaller the crack force value, the greater the probability of occurrence of cracks or delamination in the electrode 10 to be analyzed.

In the prediction step (S50), an indentation depth value when an indentation load value is the crack force value may be considered together with the crack force value in predicting occurrence of cracks or delamination of the electrode 10 to be analyzed. As shown in FIG. 5, it can be seen that the electrode with a larger interparticle attraction which does not have delamination has broken 10) at a deeper indentation depth.

Therefore, in the prediction step (S50), it may be predicted that the smaller the indentation depth value when the indentation load value is the crack force value, the greater the probability of occurrence of cracks or delamination in the electrode 10 to be analyzed.

In the prediction step (S50), strain energy may be calculated by integrating the indentation load values up to the indentation depth value when the indentation load value is a crack force value. The strain energy may be the area of the hatched region in the graph shown in FIG. 5. In the method for predicting cracks and delamination of the electrode of the present disclosure, it is possible to predict the occurrence of cracks and delamination of the electrode 10 to be analyzed based on the strain energy value.

Specifically, in the prediction step (S50), it may be predicted that the smaller the strain energy value, the greater the probability of occurrence of cracks or delamination in the electrode 10 to be analyzed.

The method for predicting occurrence of cracks and delamination of the electrode of the present disclosure may further comprise, prior to the step of preparing the electrode to be analyzed S10,
a step of preparing a standard electrode of preparing a standard electrode by applying a standard electrode slurry to one surface of an electrode current collector and then drying it;
a step of press-fitting the standard electrode of press-fitting a measuring point into the surface of the standard electrode;
a step of collecting reference data of collecting indentation load values applied to the measuring point for each indentation depth value of the measuring point for the standard electrode; and
a step of extracting a reference force of extracting an indentation load value at the time that the standard electrode is broken as a reference force value.

The standard electrode is a non-defective electrode that does not have the generated cracks or delamination, and the state of the electrode 10 to be analyzed can be determined based on the measured value of the standard electrode.

Specifically, in the prediction step (S50) of the method for predicting occurrence of cracks and delamination of the electrode of the present disclosure, occurrence of cracks and delamination of the electrode 10 to be analyzed may be predicted using the crack force value and the reference force value.

In the step of preparing a standard electrode, the standard electrode is a non-defective electrode, which does not have the generated delamination. Specifically, the standard electrode may not be separated from the current collector and may have no damage such as cracks when a specific physical condition is applied to the electrode having the determined thickness by completing the roll pressing. For example, an electrode having no separation from a current collector and no damage such as cracks when applying the force which is applied to the electrode during the electrode cutting process, etc., to an electrode under physical conditions, may be used as a standard electrode.

In one embodiment, the standard electrode slurry may be the same as the electrode slurry used to prepare the electrode 10 to be analyzed. The physical properties of the completed electrode can be determined according to manufacturing conditions such as applied thickness, drying time, drying temperature, and pressing strength during the electrode manufacturing process, and the standard electrode slurry is prepared similarly to the electrode slurry of the electrode 10 to be analyzed. However, manufacturing conditions of the standard electrode may be set under different manufacturing conditions from the electrode 10 to be analyzed.

In another embodiment, the standard electrode slurry may have a different composition ratio of a conductive agent, a binder, an active material, and a solvent from that of the electrode slurry for the electrode 10 to be analyzed or have a different composition material itself.

In the prediction step, when the crack force value is 70% or less of the reference force value, the electrode to be analyzed may be predicted as an electrode in which cracks and delamination are to occur.

### EXAMPLE

Six types of electrode slurries having different binder contents were prepared, and the respective slurries were coated, dried, and pressed to prepare a total of 12 samples of electrodes 10 to be analyzed, with two sets each.

A measuring point 100 having an indenter having a diameter of 3 to 6 pi and an angle a formed by two planes at 30 degrees was press-fitted into the electrode 10 to be analyzed at a speed of 10 μm/s, and a crack force was calculated from the indentation depth and indentation load values measured during press-fitting.

Table 1 below shows crack forces calculated for six types of electrodes A, B, C, A′, B′, and C′.

TABLE 1

| | Sample with no delamination | | | Sample with delamination | | |
|---|---|---|---|---|---|---|
| Group | A | B | C | A′ | B′ | C′ |
| Set 1 | 5.22 | 3.59 | 5.27 | 2.46 | 2.53 | 2.56 |
| Set 2 | 5.62 | 4.81 | 5.71 | 2.91 | 3.04 | 2.73 |

It can be seen that the electrodes of sample group with delamination show a crack force value 30 to 70% lower than that for the electrodes of sample group with no delamination. In Table 1, the crack force is in N.

Although the embodiments according to the present disclosure have been described above, these are only exemplary, and those skilled in the art will appreciate that various modifications and equivalent embodiments are possible. Therefore, the true technical protection scope of the present disclosure should be defined by the following claims.

### DESCRIPTION OF THE REFERENCE NUMERALS

10 . . . Electrode to be analyzed
11 . . . Current collector
100 . . . Measuring point
110 . . . First plane
120 . . . Second plane

### INDUSTRIAL AVAILABILITY

The method for predicting occurrence of cracks and delamination of the electrode according to the present disclosure can provide data for reducing defects in an electrode manufacturing process by predicting the possibility of occurrence of cracks and delamination of the electrode.

The method for predicting occurrence of cracks and delamination of the electrode according to the present disclosure can accurately express the characteristics of cohesive force between particles in the electrode.

1. A method for predicting occurrence of cracks and delamination of an electrode, comprising:
a step of preparing an electrode to be analyzed by applying an electrode slurry to one surface of an electrode current collector and then drying it;
a step of press-fitting a measuring point into a surface of the electrode to be analyzed;
a step of collecting data by collecting indentation load values applied to the measuring point for each indentation depth value of the measuring point for the electrode to be analyzed;
a step of extracting a crack force by extracting an indentation load value at the time that the electrode to be analyzed is broken as a crack force value; and
a prediction step of predicting occurrence of cracks and delamination of the electrode to be analyzed using the crack force value.

2. The method for predicting occurrence of cracks and delamination of the electrode according to claim 1, wherein in the step of preparing the electrode to be analyzed:
the electrode current collector is made of a metal foil, and
the electrode slurry is prepared by mixing an active material, a conductive agent, a binder, and a solvent.

3. The method for predicting occurrence of cracks and delamination of the electrode according to claim 1, wherein in the step of press-fitting:
one end of the measuring point is an edge formed by an intersection of a first plane and a second plane at an acute angle with each other, and
the measuring point is press-fitted into the electrode to be analyzed while contacting the edge of the measuring point with the surface of the electrode to be analyzed.

4. The method for predicting occurrence of cracks and delamination of the electrode according to claim 3, wherein:
a length of the edge formed by the first plane and the second plane is 2 mm to 10 mm, and
the acute angle formed by the first plane and the second plane is 15 degrees to 45 degrees.

5. The method for predicting occurrence of cracks and delamination of the electrode according to claim 4, wherein:
the measuring point moves in a direction perpendicular to the surface of the electrode to be analyzed and is press-fitted into the surface of the electrode to be analyzed, and
the measuring point moves at a speed of 50 μm/s or less.

6. The method for predicting occurrence of cracks and delamination of the electrode according to claim 1, wherein in the step of extracting the crack force, the crack force value is the indentation load value when the indentation load value has a maximum value with respect to the indentation depth value.

7. The method for predicting occurrence of cracks and delamination of the electrode according to claim 1, wherein in the prediction step, it is predicted that the smaller the crack force value, the greater the probability of occurrence of cracks or delamination in the electrode to be analyzed.

8. The method for predicting occurrence of cracks and delamination of the electrode according to claim 1, wherein in the prediction step, the indentation depth value when the indentation load value is the crack force value is considered together with the crack force value in predicting occurrence of cracks or delamination of the electrode to be analyzed.

9. The method for predicting occurrence of cracks and delamination of the electrode according to claim 8, wherein in the prediction step, it is predicted that the smaller the indentation depth value when the indentation load value is the crack force value, the greater the probability of occurrence of cracks or delamination in the electrode to be analyzed.

10. The method for predicting occurrence of cracks and delamination of the electrode according to claim 8, wherein in the prediction step:
a strain energy value is calculated by integrating the indentation load values up to the indentation depth value when the indentation load value is the crack force value, and
the occurrence of cracks and delamination of the electrode to be analyzed is predicted based on the strain energy value.

11. The method for predicting occurrence of cracks and delamination of the electrode according to claim 10, wherein in the prediction step, it is predicted that the smaller the strain energy value, the greater the probability of occurrence of cracks or delamination in the electrode to be analyzed.

12. The method for predicting occurrence of cracks and delamination of the electrode according to claim 1, wherein, prior to the step of preparing the electrode to be analyzed, the method further comprises:
a step of preparing a standard electrode by applying a standard electrode slurry to one surface of an electrode current collector and then drying it;
a step of press-fitting the measuring point into a surface of the standard electrode;
a step of collecting reference data by collecting indentation load values applied to the measuring point for each indentation depth value of the measuring point for the standard electrode; and
a step of extracting a reference force by extracting an indentation load value at the time that the standard electrode is broken as a reference force value;
wherein in the prediction step, the occurrence of cracks and delamination of the electrode to be analyzed is predicted using the crack force value and the reference force value.

13. The method for predicting occurrence of cracks and delamination of the electrode according to claim 12, wherein in the prediction step, when the crack force value is 70% or less of the reference force value, the electrode to be analyzed is predicted as an electrode in which cracks and delamination are to occur.
